(19) United States
(12) Patent Application Publication
(10) Pub. No.: US 2012/0146625 A1
(43) Pub. Date: Jun. 14, 2012

(54) SENSOR ARRANGEMENT

(75) Inventors: Werner Grommer, Ortenburg (DE); Christian Pfaffinger, Ruhstorf a. d. Rott (DE); Axel Seikowsky, Ortenburg (DE)

(73) Assignee: MICRO-EPSILON MESSTECHNIK GMBH & CO.KG, Ortenburg (DE)

(21) Appl. No.: 13/391,531

(22) PCT Filed: Oct. 5, 2010
(86) PCT No.: PCT/DE2010/001162

§ 371 Date: Feb. 21, 2012

(30) Foreign Application Priority Data
Oct. 6, 2009 (DE) 10 2009 048 408.6
Sep. 28, 2010 (DE) 10 2010 046 700.6

(51) Int. Cl. G01B 7/14

(52) U.S. Cl. 324/207.12; 324/207.11

(57) ABSTRACT

The invention relates to a sensor arrangement for detecting at least one of the movement and the position of two components of an assembly, which are located close to each other or are disposed one inside the other and can be moved relative to each other, said sensor arrangement comprising at least one first sensor for detecting at least one of the movement and the position of the one component and a second sensor for detecting at least one of the movement and the position of the other component, the sensors functioning according to different measuring principles without affecting each other mutually.

### CROSS REFERENCE TO RELATED APPLICATIONS

This application is a national stage application, filed under 35 U.S.C. §371, of International Application No. PCT/DE2010/001162, filed Oct. 5, 2010, which claims priority to German Application Nos. 10 2010 046 700.6, filed Sep. 28, 2010 and 10 2009 048 408.6, filed Oct. 6, 2009, which is hereby incorporated by reference in its entirety.

### BACKGROUND

### Technical Field

The invention relates to a sensor arrangement for detecting the movement/position of two components of an assembly that are arranged close to each other or are disposed one inside the other and can be moved relative to each other.

In the specific case the assembly can be a disengaging bearing of a dual clutch transmission comprising an inside bearing as the first component and an outside bearing as the second component. The application in a so-called engaging device is also conceivable.

### Description of Related Art

With respect to the background art the following may be stated:

In so-called dual clutch transmissions—also called direct shift gears (DSG)—disengaging and engaging devices are needed for two independent disengaging and engaging operations.

In order to determine the position of the two necessary bearings, two independent position sensors are needed. To date, a magnetic sensor (PLCD sensor [permanent magnetic linear contactless displacement sensor]) has been used for the external bearing. In this case a magnet is mounted on the anti-rotation element of the bearing (see, for example, EP 1 898 111 A2 and DE 102 42 841 A1). Since the two disengaging and engaging devices may occupy only a small amount of the installation space, the internal bearing is mounted in such a way that it is arranged concentrically inside the external bearing. This arrangement significantly reduces the amount of installation space that is required. However, at the same time it also means a reduction in the space for a position sensor. In such an arrangement there is no room for a sensor working on the PLCD principle. In addition, the two absolutely mandatory magnets of the sensors would interfere with each other and, in so doing, falsify the measurement results.

Dual clutch transmissions consist of two partial clutches and have been known for a long time from practical application. The advantage of such transmissions lies in the ability to shift between the gear ratios without interrupting the traction force. Such transmissions are used predominantly in motor vehicles, in particular as direct shift gears (DSG) or parallel shift gears (PSG).

However, dual clutch transmissions are also used elsewhere—that is, anywhere it is necessary to transmit power by means of gear mechanisms; if possible, without interrupting the traction force. The fundamental principle of the dual clutch transmission is based on two partial gear mechanisms that can be shifted independently of each other. While the one clutch is closed and the force of the drive is transmitted to a partial gear mechanism, the corresponding gear is preselected in the course of the shifting operation in the other partial gear mechanism. Then the other clutch is closed, while the first clutch is opened at the same time. This strategy allows the torque to be transmitted continuously from one to the other gear step. This is called the torque transfer. The shifting operation occurs in an extremely short period of time without interruption of the traction force, and thus with high efficiency. As a result, dual clutch transmissions represent a good compromise between high convenience and high efficiency. However, the shifting operation demands a precise control, so that there are no torque losses. Not until the complex control process is understood and applied can the dual clutch transmissions take hold.

The detection of the momentary clutch position is absolutely mandatory for achieving an efficient control. In this respect, reference is made, for example, to the DE 10 2007 037 589 A1 and the references and publications cited in opposition therein. The clutches known from the prior art can be operated in different ways—for example, by hydraulic or electrical means. In any case, it is necessary to detect the position of each partial gear mechanism, so that, irrespective of the respective position of one clutch, the other can be controlled.

Detection of the position of individual clutches has been known—per se—for a long time from practical application. To this end, there exists a broad spectrum of possibilities for using position sensors. There are, inter alia, sensors working on the magnetic principle or the inductive or eddy current principle. The DE 197 16 600 A1 shows an electric measurement value transducer that is connected to the disengaging bearing of a clutch with a linkage. Other solutions show magnetic sensors, such as Hall sensors, which detect the position of a magnet. In this case the magnet is fastened to the piston of the disengaging bearing of the clutch with hydraulic clutch actuations, whereas the sensor is mounted on the stationary bearing (see in this case DE 196 52 785 B4,DE 102 42 841 A1 and DE 10 2004 027 117 A1). The EP 0 936 439 B1 discloses a sensor that determines the position of the piston of a disengaging bearing according to the eddy current principle.

In the case of dual clutches, it is necessary to detect the position of two components that are moved relative to one another. In the case of hydraulically operated disengaging bearings, they are typically two pistons that are arranged concentrically inside one another or that mesh with one another. Whereas in the case of a single piston it is relatively easy to detect the position of the piston with the sensor arrangements known from the prior art, it is much harder with a dual disengaging device. This difficulty is due to the fact that the installation space is extremely restricted. In addition, the lateral measurement or detection of the piston lying within is not possible or is possible only with considerable effort.

According to the DE 199 36 886 A1, position sensors are integrated into the clutch actuators. These actuators are mounted outside the disengaging bearings by way of an actuating linkage and act only indirectly on the clutch. As a result, the amount of installation space that is required is large. The indirect actuation leads to a significant amount of wear and tear and to errors in the measurement.

According to the DE 103 205 24 A1, the digital sensors for detecting the actual position are mounted on shift cylinders.

The DE 10 2007 037 589 A1 describes the control of dual clutch transmissions by means of two position sensors. The exact arrangement or layout of the sensors is not described therein.

When using magnetic sensors there is the risk of mutual interference. Since magnetizable materials are also frequently used in disengaging bearings, the magnetic field distribution can be affected in an incalculable way. This is the case especially if the pistons move independently of one another. Then the magnet, which belongs to the first position sensor, could also interfere with the second position sensor and, as a result, cause faults in the measurement.

### BRIEF SUMMARY

In light of the aforementioned discussion of the prior art, the object of the present invention is to design and improve a sensor arrangement in such a way that it enables an independent measurement of the position of two movable components that are located close to each other. At the same time, the object is to eliminate the possibility of the two sensors mutually affecting each other or interfering with one another. The sensor arrangement should be as compact as possible and, as a result, be usable in locations with negligible space for installation.

The aforementioned engineering object is achieved with the features disclosed in patent claim 1. According to these features, a sensor arrangement for detecting the movement/position of two components of an assembly that are located close to each other or are disposed one inside the other and can be moved relative to each other is equipped with at least a first sensor for detecting the movement/position of the one component and a second sensor for detecting the movement/position of the other component, wherein the sensors function according to different measuring principles without interfering with each other.

### DETAILED DESCRIPTION

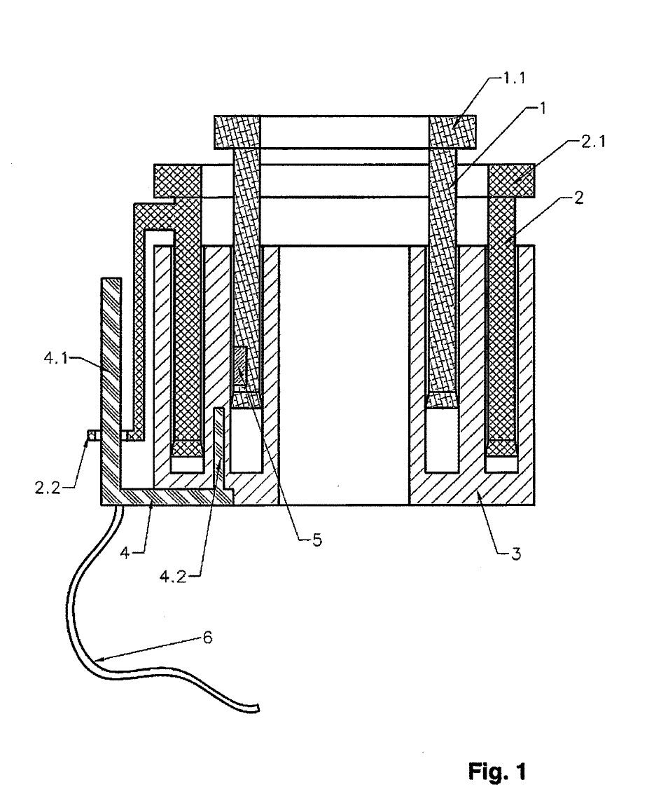

The invention is explained in detail below with reference to the FIGS. 1 to 4:

According to the invention, a sensor 4.2, which works, for example, on the MDS principle (magnetic distance sensor according to the DE 10 2007 062 862 A1), is used for the inside bearing 1.1. Such a sensor has the advantage that it is extremely compact. It can be totally encapsulated with a non-magnetic metal—for example, aluminum—a feature that has a very good effect on interference emission and irradiance. In the case of the disengaging device or the engaging device, the sensor can be installed between the internal and the external pressure chamber of the hydraulic system, according to FIG. 1.

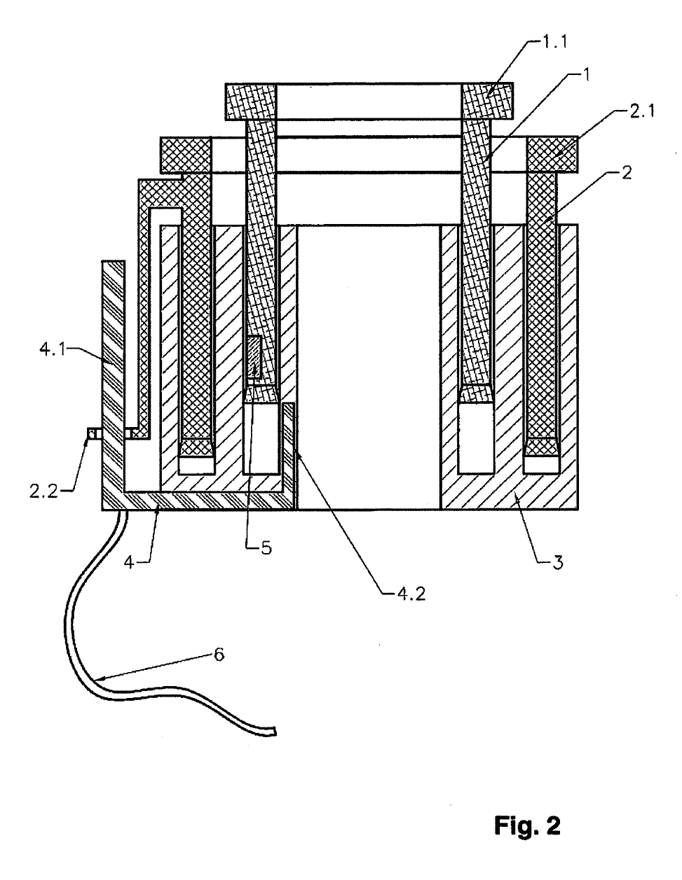

Another possibility is the arrangement between the internal pressure chamber and the shaft, according to FIG. 2. The encoder magnet 5 is mounted on or in the internal cylinder 1. A position detection occurs when the magnet moves in the direction of the sensor, but is not yet underneath the sensor. Hence, the sensor does not have to be arranged laterally relative to the magnet over the entire range of movement, a feature that offers significant advantages with respect to the installation space.

The position of the outside bearing 2.1 is detected by a sensor 4.1, according to EP 0 654 140 A1. In this case, the already existing anti-rotation element has an oblong hole 2.2, which serves as the target for the sensor. An additional magnet can be eliminated. The two positions are determined on the basis of physically different measurement methods. This feature eliminates the possibility of the sensors mutually affecting one another or interfering with each other.

If the bearings that are used are made of a ferromagnetic material, then the situation may arise that the external bearing 2.1 may interfere with the measurement signal of the sensor. Since the position of this bearing is known, for example, by means of the measurement according to the principle disclosed in the EP 0 654 140 A1, this error can be easily compensated.

In order to achieve the smallest possible temperature error in the application-dependent wide operating temperature range, a compensation of the temperature dependence is desired. For this purpose it is necessary to have temperature information that can also be determined in a relatively simple way for the sensor combination through the use of the sensor 4.1. Hence, the sensor 4.1 is fed a direct current voltage. The variation in this DC voltage is a measure for the temperature at the sensor 4.1. This feature makes it possible to eliminate an additional temperature probe in the sensor, so that the number of required sensor lines 6 as well as the design space requirement are minimized. On the assumption that the same ambient temperature prevails for both sensors, then the temperature information can also be used for the compensation of both sensor signals.

Since the two sensor signals dwell in different frequency bands, they can be easily separated from each other in the evaluation circuit following transmission. Thus, there is no cross-talk between the two channels.

The structural design of the sensor 4 enables the simultaneous assembly of both sensors.

The sensor 4.1 can serve together with the target ring 2.2 as the anti-rotation element of the external bearing 2 and 2.1. An additional securing element on the housing can be dispensed with, so that the result is a simpler design of the bearing housing 3.

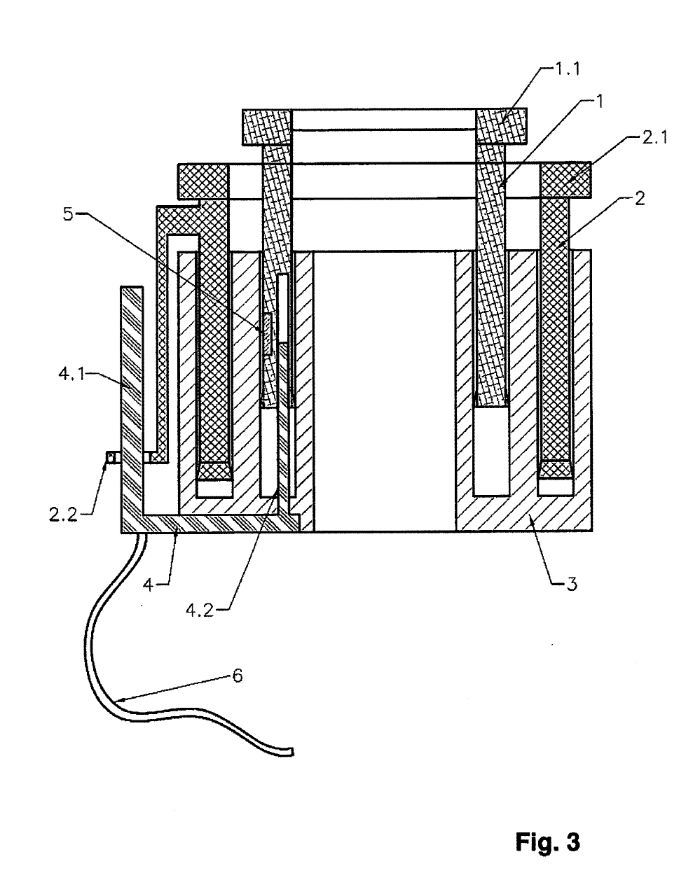

The sensor 4.2—for example, an MDS sensor—can also be used as an anti-rotation element in a suitable design (for example, in an aluminum or stainless steel housing) (FIG. 3). In this case, the sensor 4 has to outwardly seal off the pressure chamber. However, a major advantage is the fact that it is possible to dispense with a difficult mechanical machining step at the bearing housing 3.

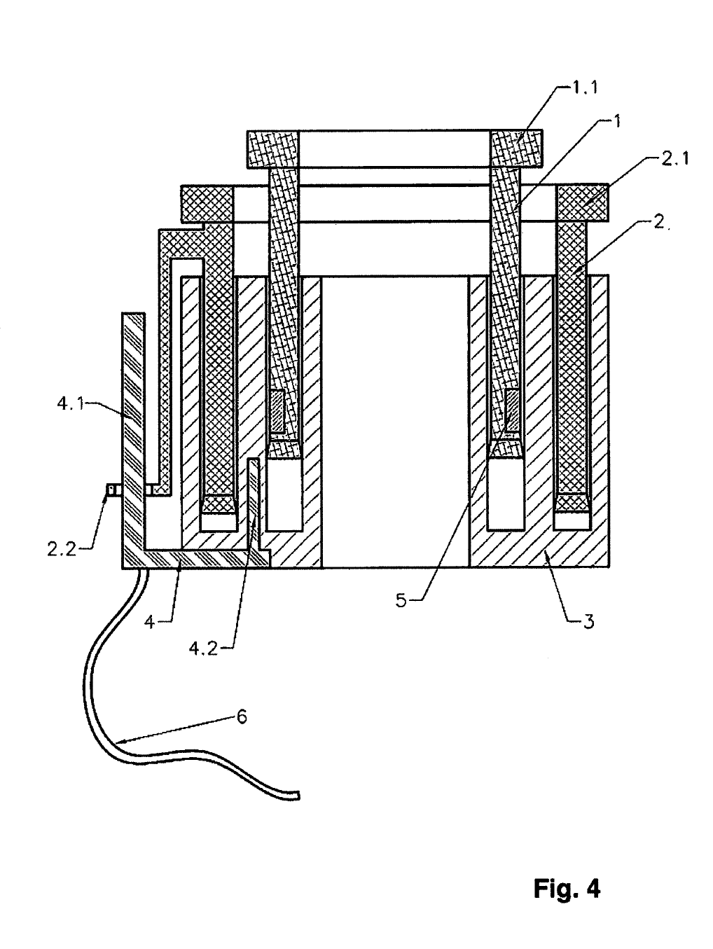

If a ring magnet according to FIG. 4 is used, then there is no need for an anti-rotation element of the internal bearing that would be required only for the measurement.

In summary, the advantages of the sensor arrangement according to the invention can be described in key words as follows:
two independent measuring principles (in general), which do not interfere with each other;
the first sensor (for example, an MDS sensor) detects by magnetic means the piston position (also through non-magnetic materials;
the second sensor measures laterally with compact design;
the sensors can be used for mutual calibration, if, for example, one sensor is located at the (stable) zero point and the other sensor is somewhere else in the measuring range;
the sensors can be used mutually for temperature compensation;
the arrangement of the sensors can be freely selected on the basis of different measuring principles; in particular, they can also arranged immediately adjacent;
the sensors can have a structural design that allows them to be mounted as a unit.

Finally, it must also be noted that the sensor arrangement according to the invention can be used not only in disengaging bearings for dual clutches, but also in any location where two components that are arranged close to each other or inside one another carry out movements relative to each other; and this movement is to be detected with contactless sensors. A mutual interference between the sensors is ruled out. Installation space is routinely restricted, especially if the movable components are dual cylinders, telescope cylinders and the like.

### LIST OF REFERENCE NUMERALS

1 cylinder
1.1 inside bearing
2 external bearing
2.1 outside bearing
2.2 oblong hole, target ring
3 bearing housing
4 sensor
4.1 external sensor
4.2 internal sensor
5 encoder magnet
6 sensor lines

1-9. (canceled)

10. Sensor arrangement for detecting at least one of the position and the movement of two components of an assembly that are disposed one inside the other and can be moved relative to each other, said sensor arrangement comprising at least a first sensor for detecting at least one of the movement and the position of the internally disposed component and a second sensor for detecting at least one of the movement and the position of the externally disposed component, wherein:
the first and the second sensor function according to different measuring principles without interfering with each other;
at least one of the position and the movement of the internally disposed component is detected by the first sensor, the first sensor being a magnetic field sensor; and
at least one of the position and the movement of the externally disposed component is detected by the second sensor, the second sensor being a non-magnetic field sensor.

11. Sensor arrangement, as claimed in claim 10, wherein:
the assembly comprises a disengaging bearing of a dual clutch transmission, the dual clutch transmission comprising an inside bearing (component) and an outside bearing (component); and
the first and the second sensors are used for detecting at least one of the movement and the position of the bearings relative to each other.

12. Sensor arrangement, as claimed in claim 11, wherein the assembly comprises a hydraulically operated disengaging bearing with two concentrically intermeshing pistons, the two concentrically intermeshing pistons comprising the two components.

13. Sensor arrangement, as claimed in claim 10, wherein:
the components are made at least partially of ferromagnetic material; and
any interference with the measurement signal of the magnetic field sensor on the part of the external component is compensated via the determined position of the external component.

14. Sensor arrangement, as claimed in claim 13, wherein the components are made totally of ferromagnetic material.

15. Sensor arrangement, as claimed in claim 10, wherein in order to compensate for the temperature, a DC voltage is applied at the sensor for the external component, so that a change in the direct current is a measure for the temperature at the sensor, as a result of which temperature information can be derived.

16. Sensor arrangement, as claimed in claim 15, wherein the temperature information that is obtained represents the temperature of the signals of both the first and the second sensor.

17. Sensor arrangement, as claimed in claim 10, wherein the sensor signals are assigned to different frequency bands, so that a separation of optionally compensated signals may take place in an evaluation circuit.
